(19) United States
(12) Patent Application Publication
(10) Pub. No.: US 2010/0149241 A1
(43) Pub. Date: Jun. 17, 2010

(54) IMAGE RECORDING APPARATUS

(75) Inventor: Tsuyoshi FURUHATA, Tokyo (JP)

Correspondence Address: FRISHAUF, HOLTZ, GOODMAN & CHICK, P.C., 220 Fifth Avenue, 16th Floor, New York, NY, 10017-2023, US

(73) Assignee: Olympus Corporation, Tokyo (JP)

(21) Appl. No.: 12/630,340

(22) Filed: Dec. 3, 2009

(30) Foreign Application Priority Data
Dec. 17, 2008 (JP) 2008-320556

(51) Int. Cl. B41J 29/38

(52) U.S. Cl. 347/12

(57) ABSTRACT

An image recording apparatus is provided with at least one recording head having a nozzle array configured by a plurality of nozzles and a nozzle array drive unit for driving the nozzle array, and a conveyance mechanism for loading and conveying a record medium for a recording process using ink conveyed upstream from a conveyance route and jetted from the plurality of nozzles, and includes: at least a nozzle array drive control unit controlling the nozzle array drive unit; and a temperature measuring unit detecting the temporarily of the nozzles. With the configuration, the nozzle array drive control unit measures a temperature of the nozzles, and performs the process of heating ink by performing a weak vibration so that the ink cannot be jetted when the measured temperature is lower than a predetermined temperature.

### CROSS REFERENCE TO RELATED APPLICATIONS

This application is based upon and claims the benefit of priority from the prior Japanese Patent Application No. 2008-320556, filed on Dec. 17, 2008, the entire contents of which are incorporated herein by reference.

### BACKGROUND OF THE INVENTION

1. Field of the Invention

The present invention relates to an image recording apparatus for recording an image on a record medium such as paper, film, etc. and a method for controlling the device, and more specifically to an image recording apparatus for suppressing the inrush current generated when nozzle drive is performed to heat ink, and a method for controlling the image recording apparatus.

2. Description of the Prior Art

A full-line color printer in an inkjet system has been well known as an image recording apparatus. With the color printer, a recording head having a plurality of nozzles is provided for jetting ink in a direction (main scanning direction) orthogonal to the conveyance direction (subscanning direction) in which a record medium is conveyed.

With the color printer (image recording apparatus), a character and an image can be recorded on a record medium by jetting ink from a plurality of nozzles formed on a recording head to the record medium. If a state in which jet ink drops are not jetted from the nozzles continues, the water content etc. as a solvent of the ink evaporates from the nozzles, and the viscosity of the ink near the nozzles increases. If the viscosity of the ink near the nozzles increases, the nozzles are clogged and the ink cannot be jetted in a printing operation. Although the ink is jetted, the original size or the speed the jetted ink cannot be maintained.

Therefore, a meniscus is vibrated with the ink drops protected from being jetted with a view to preventing the viscosity of the ink drops in the nozzles from increasing, thereby performing no inkjet drive to reduce the viscosity of the ink in the nozzles.

As the related technology, the patent document (Japanese Laid-open Patent Publication No. 11-138798) discloses the technique of generating heat by vibrating a recording head during a non-recording period on the basis of the result of measurement by a temperature measuring apparatus for measuring the temperature of the recording head, thereby heating the ink in the liquid container of the recording head. In this case, since the amplitude of the vibration is proportional to the energy, the heating energy increases by increasing the amplitude. Therefore, fine temperature control and quick heating can be performed by controlling the amplitude of a heating signal. Thus, the technique suppresses a bad influence on an image due to a change in the viscosity of ink caused by a temperature.

Generally, the no inkjet drive to suppress the viscosity of ink (hereinafter referred to as no inkjet drive A) and the no inkjet drive to heat ink (hereinafter referred to as no inkjet drive B) have the following relationship.

no inkjet drive B>no inkjet drive A

FIG. 1 is a graph indicating the relationship between the starting timing of the no inkjet drive B and the rise of the temperature of ink. After powering up an image recording apparatus 1, and if the recording head does not reach an optimum jet temperature t, the ink heating control is performed until the head reaches the optimum jet temperature t. In this case, the no inkjet drive B is performed, and larger power is required as compared with the no inkjet drive A.

FIGS. 2A through 2C illustrate the relationship among the heating start timing when the no inkjet drive B is started, the current in the circuit, and the temperature of ink. That is, FIG. 2A illustrates the heating start timing, FIG. 2B illustrates the current in the circuit, and FIG. 2C illustrates the characteristic of the temperature of ink.

As illustrated in FIGS. 2A and 2B, when the drive of the no inkjet drive B is started, the current in the circuit sharply increases and exceeds a stationary current value I, thereby passing an inrush current Ip. In this case, to record a color image, the drive of the no inkjet drive B is started to heat the ink in all colors of black (K), cyan (C) magenta (M), and yellow (Y) as illustrated in FIG. 3A, and the current at the peak is superposed, thereby passing a large inrush current (Ip′) as illustrated in FIG. 3B. Therefore, to drive the no inkjet drive B, a large-capacity power supply apparatus is required.

### SUMMARY OF THE INVENTION

The present invention provides an image recording apparatus capable of driving a no inkjet drive B while suppressing the maximum power consumption, and a method for controlling the image recording apparatus.

To attain the above-mentioned object, the image recording apparatus as an aspect of the present invention is provided with at least one recording head having a nozzle array configured by a plurality of nozzles and a nozzle array drive unit for driving the nozzle array, and a conveyance mechanism for loading and conveying a record medium for a recording process using the ink conveyed upstream from the conveyance route and jetted from the plurality of nozzles, and includes at least a nozzle array drive control unit for controlling the nozzle array drive unit, and a temperature measuring unit for detecting the temporarily of the nozzles. The nozzle array drive control unit measures the temperature of the nozzles, and performs the process of heating ink by performing a weak vibration so that the ink cannot be jetted when the measured temperature is lower than a predetermined temperature.

The method for controlling the image recording apparatus as another aspect of the present invention is provided with at least one recording head having a nozzle array configured by a plurality of nozzles and a nozzle array drive unit for driving the nozzle array, a conveyance mechanism for loading and conveying a record medium for a recording process using the ink conveyed upstream from the conveyance route and jetted from the plurality of nozzles, a nozzle array drive control unit for controlling the nozzle array drive unit, and a temperature measuring unit for detecting the temperature of the nozzles. The nozzle array drive control unit measures the temperature of the nozzles and performs the process of heating ink by performing a weak vibration so that the ink cannot be jetted when the measured temperature is lower than a predetermined temperature.

### BRIEF DESCRIPTION OF THE DRAWINGS

FIG. 1 is an explanatory view of the prior art technology, and illustrates the relationship between the timing of starting the no inkjet drive B and the temperature of ink;

FIG. 2A illustrates the drive start timing of the prior art technology;

FIG. 2B illustrates the characteristic of the current in the circuit according to the prior art technology;

FIG. 2C illustrates the characteristic of the temperature of ink according to the prior art technology;

FIG. 3A is an explanatory view of the prior art technology, and illustrates the timing of starting the no inkjet drive B of each color;

FIG. 3B is an explanatory view of the prior art technology, and illustrates the size of an inrush current;

FIG. 4 illustrates the concept of an example of the configuration according to an embodiment of the image recording apparatus of the present invention;

FIG. 5 is a side view schematically illustrating an example of the arrangement of an embodiment of the image recording apparatus according to the present invention;

FIG. 6 is a top view schematically illustrating an example of the arrangement of an embodiment of the image recording apparatus according to the present invention;

FIG. 7A illustrates the timing of issuing an instruction to start drive to the nozzle array drive unit of each color;

FIG. 7B is an explanatory view of the current characteristic according to the first embodiment;

FIG. 8 is a block diagram of the recording head to be driven;

FIG. 9 is an explanatory view of an example of a variation of the first embodiment, and is a block diagram of the recording head to be driven;

FIG. 10A is an explanatory view of the second embodiment of the present invention, and illustrates a frequency change;

FIG. 10B is an explanatory view of the second embodiment of the present invention, and illustrates a voltage change;

FIG. 10C is an explanatory view of the second embodiment of the present invention, and illustrates a current change;

FIG. 11A is an explanatory view of an example of a variation of the second embodiment, and illustrates the configuration of simultaneously starting heating a recording head; and

FIG. 11B is an explanatory view of an example of a variation of the second embodiment, and illustrates the current to be supplied to a recording head.

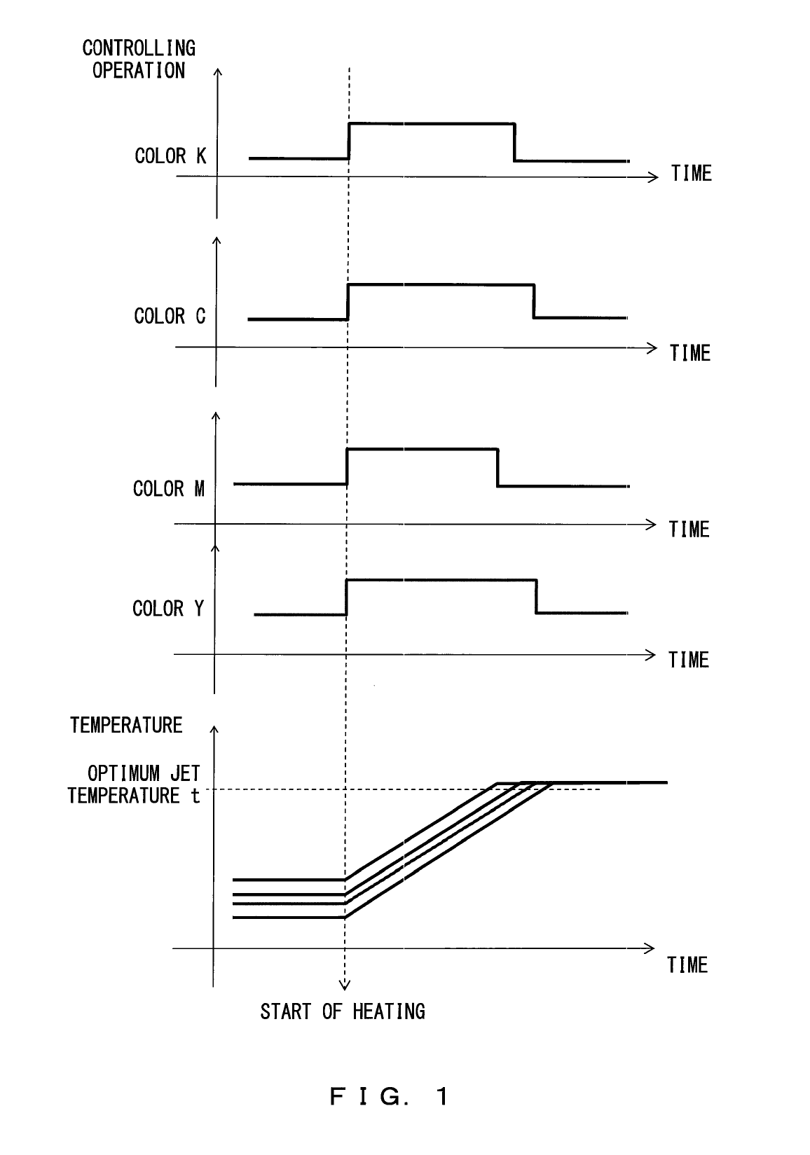

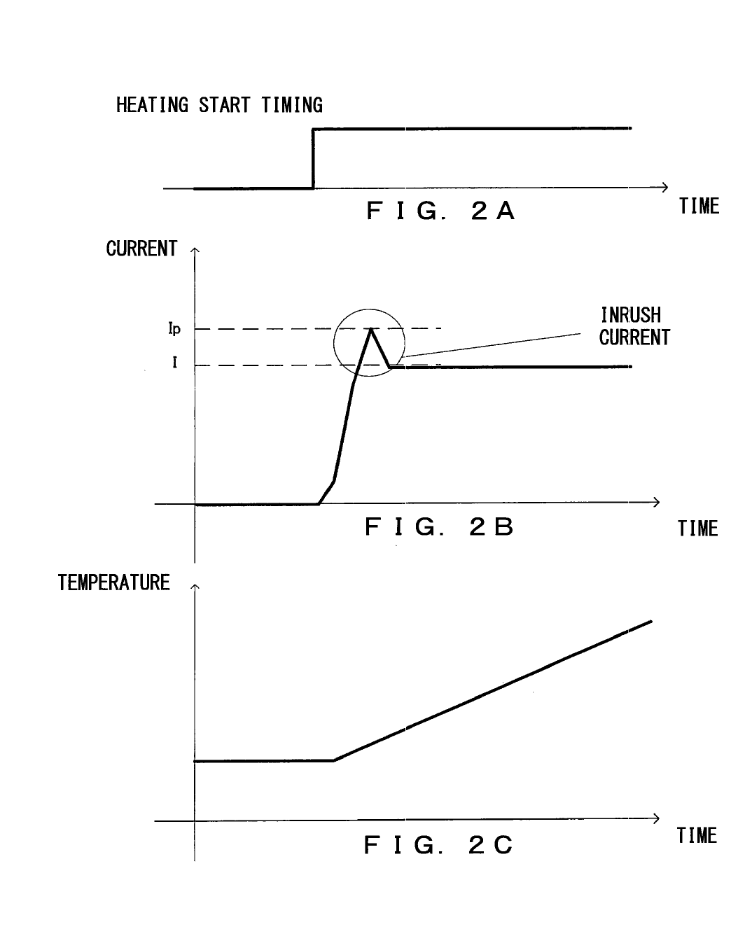

### DESCRIPTION OF THE PREFERRED EMBODIMENT

The embodiments of the present invention are described below in detail with reference to the attached drawings.

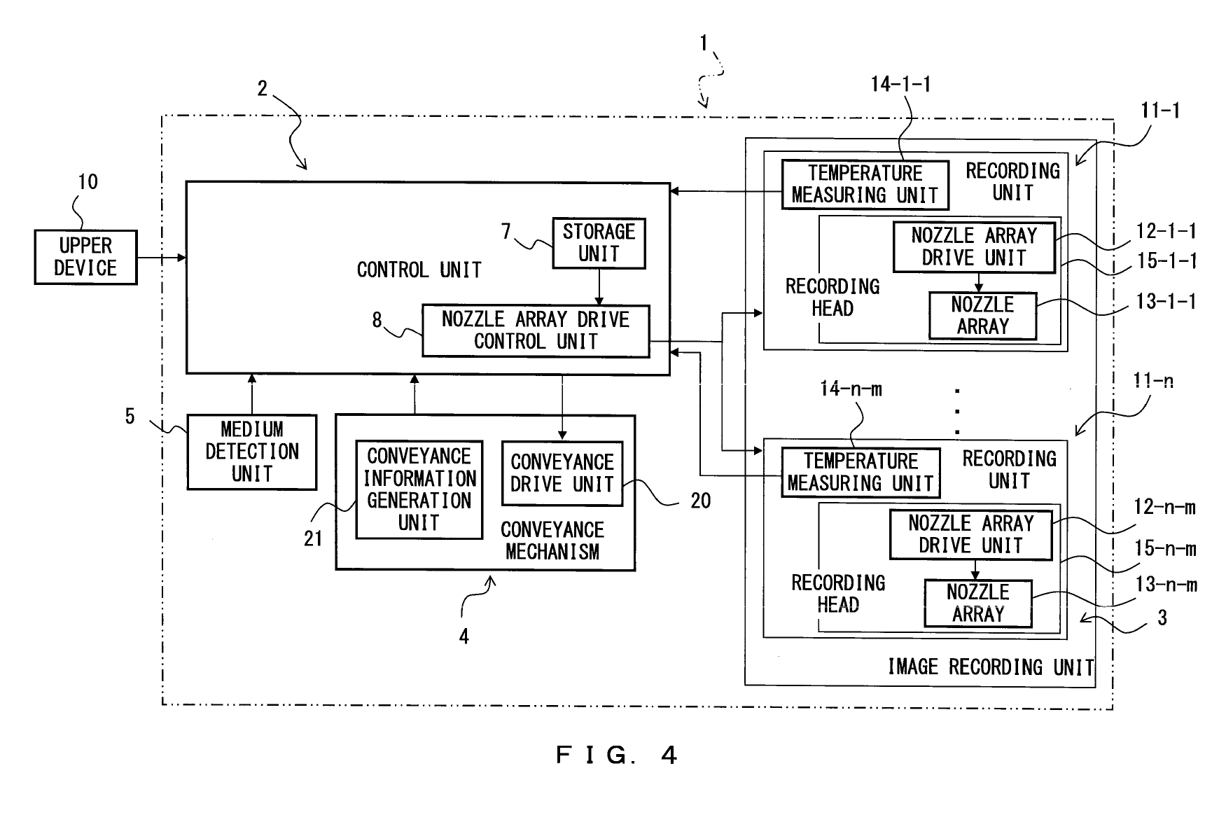

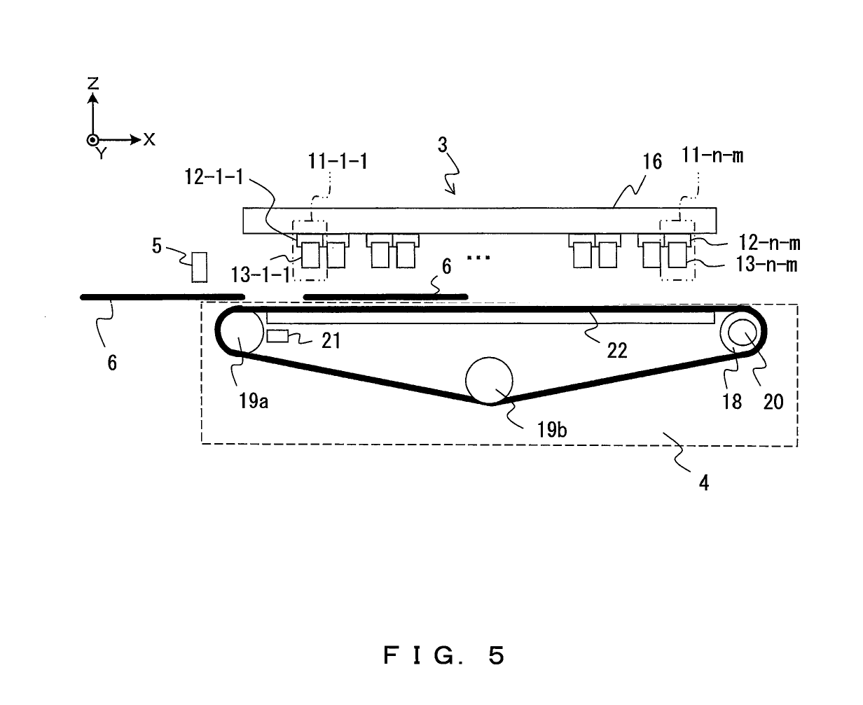

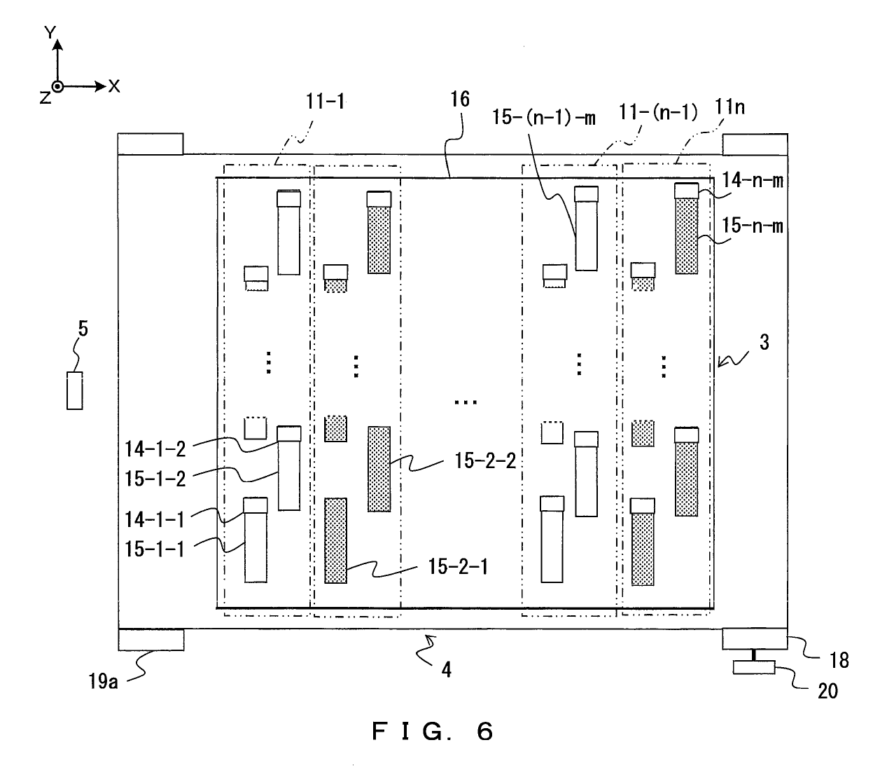

FIG. 4 illustrates the concept of an example of the configuration according to an embodiment of the image recording apparatus 1 of the present invention. FIG. 5 is a side view schematically illustrating an example of the arrangement of an embodiment of the image recording apparatus 1 according to the present invention. FIG. 6 is a top view schematically illustrating an example of the arrangement of an embodiment of the image recording apparatus 1 according to the present invention.

In the description of each embodiment, the conveyance direction of a record medium 6 is defied as an X-axis direction or a subscanning direction, the direction orthogonal to the conveyance direction is defined as a Y-axis direction or a main scanning direction, or a subdirection of the record medium 6, and the direction orthogonal to the XY plane is defined as a Z-axis direction or a vertical direction.

As illustrated in FIG. 4, the image recording apparatus 1 is provided with at least a control unit 2, an image recording unit 3, a conveyance mechanism 4, and a medium detection unit 5. The control unit 2 controls the entire image recording apparatus 1, and the image recording unit 3 records the image data on the record medium 6. The conveyance mechanism 4 conveys the record medium 6 to the image recording unit 3. Furthermore, the medium detection unit 5 detects the end unit of the record medium 6 to be conveyed, and notifies the control unit 2 of the detected information.

The image recording apparatus 1 is additionally provided with a supply unit for supplying the record medium 6 not illustrated in the attached drawings to the conveyance mechanism 4, a recovery unit for recovering the nozzle array from the clogging of ink and dirt, and a storage unit for storing the record medium 6.

The control unit 2 is provided with at least a storage unit 7 and a nozzle array drive control unit 8, controls the image recording unit 3, and also controls each component of the image recording apparatus 1. The control unit 2 is configured by a processing circuit including an MPU (microprocessor unit (arithmetic device)) having a control function and an arithmetic function, ROM (read only memory) storing a control program, etc. and non-volatile memory storing a set value etc. about the control of the image recording apparatus 1.

In addition, an upper device 10 such as a personal computer (PC) etc. connected to the image recording apparatus 1 through a LAN (local area network) etc. is provided with an input unit including a switch panel as an input function, a touch panel for a display screen, a keyboard, etc. as an input function, and provided with a display unit such as a liquid display panel, a CRT display, etc. as an output function. The above-mentioned input function and display function can be incorporated into a unitary construction or configured separately.

On the other hand, the image recording unit 3 is provided with at least recording units 11-1 through 11-n. The recording units 11-1 through 11-n are provided with recording heads 15-1-1 through 15-n-m, and the recording heads are configured by a plurality of nozzle array drive units 12-1-1 through 12-n-m and nozzle arrays 13-1-1 through 13-n-m. The recording units 11-1 through 11-n are provided with temperature measuring units 14-1-1 through 14-n-m. The recording units 11-1 through 11-n with the above-mentioned configuration are attached to a carriage 16 as illustrated in FIG. 5.

In the initializing operation during power-up, prior to the image recording process, the temperature measuring units 14-1-1 through 14-n-m measure the temperature of ink of the corresponding nozzle array drive units 12-1-1 through 12-n-m, and notify the control unit 2 of the measurement result. The nozzle array drive control unit 8 of the control unit 2 reads the information about the optimum temperature that which ink is jetted from the storage unit 7, and compares the information with the information about the temperature of ink notified from the temperature measuring units 14-1-1 through 14-n-m. If the temperature of ink notified from the temperature measuring units 14-1-1 through 14-n-m is lower, the corresponding nozzle array drive units 12-1-1 through 12-n-m are made to drive the above-mentioned no inkjet drive B. On the other hand, even at the optimum temperature t for jetting ink, the nozzle array drive control unit 8 of the control unit 2 has the control function of driving the no inkjet drive A to prevent the higher viscosity of ink or to uniformly hold the density.

In the above-mentioned operation, upon receipt of an instruction to start recording images from the upper device 10, the control unit 2 (nozzle array drive control unit 8) instructs the nozzle array drive units 12-1-1 through 12-n-m to start recording an image, and drives the nozzle arrays 13-1-1 through 13-n-m to jet the ink.

In the above-mentioned process, the recording units 11-1 through 11-n record image data received from the control unit 2 on the record medium 6 according to the position information about the record medium 6 acquired from the medium detection unit 5 and the conveyance mechanism 4.

As illustrated in FIG. 5, the conveyance mechanism 4 is provided with a drive roller 18, driven rollers 19a and 19b, a conveyance drive unit 20, a conveyance information generation unit 21, and a conveyance member 22. As illustrated in FIG. 5, the conveyance surface of the conveyance mechanism 4 is provided opposite the jet outlet of the plurality of recording units 11-1 through 11-n. With the configuration, the conveyance drive unit 20 separately arranged in the frame rotates the conveyance member 22, and conveys the record medium 6.

The medium detection unit 5 is arranged between the supply unit not illustrated in the attached drawings and the conveyance mechanism 4. The medium detection unit 5 detects, for example, the leading end of the record medium 6. As necessary, the trailing end of the record medium 6 can be detected.

Next, the normal operation of the image recording apparatus 1 with the above-mentioned configuration is briefly described below. When image data and the job information about an instruction of the number of recorded sheets, an instruction of single-sided or double-sided recording, etc. are input from the upper device 10, the recording operation is started.

First, when an instruction to start the image recording operation is issued from the control unit 2, the record medium 6 conveys the record medium 6 sheet by sheet from the supply unit not illustrated in the attached drawings, and supplied it to the conveyance mechanism 4. In this case, the medium detection unit 5 detects the leading end of the record medium 6 being conveyed, and outputs a detection signal to the control unit 2.

The control unit 2 notifies the conveyance information generation unit 21 of the conveyance mechanism 4 of the trigger information for generation of conveyance information. Upon receipt of the notification, the conveyance information generation unit 21 generates an encoder pulse to use it as a synchronization signal in performing an image recording process by the recording units 11-1 through 11-n. For example, the control unit 2 stores the number of pulses as the timing of starting jetting ink from nozzles, and when the number matches the encoder pulse generated by the conveyance information generation unit 21, the ink is jetted from the nozzles toward the record medium 6 on the conveyance member 22.

The control unit 2 jets ink from the nozzles according to the image data provided from the upper device 10, and records the image on the record medium 6. Thus, the image recorded medium 6 is conveyed to the eject unit not illustrated in the attached drawings but provided downstream to the conveyance mechanism 4, and stored.

Described below is the control of heating ink by the image recording apparatus 1 performing the recording operation with the above-mentioned configuration according to the present embodiment.

As described above, the control unit 2 (nozzle array drive control unit 8) acquires temperature information from the temperature measuring units 14-1-1 through 14-n-m, and compares the information with the temperature information stored in the storage unit 7. If the image record does not refer to a possible temperature, a heat instruction is issued to the nozzle array drive units 12-1-1 through 12-n-m.

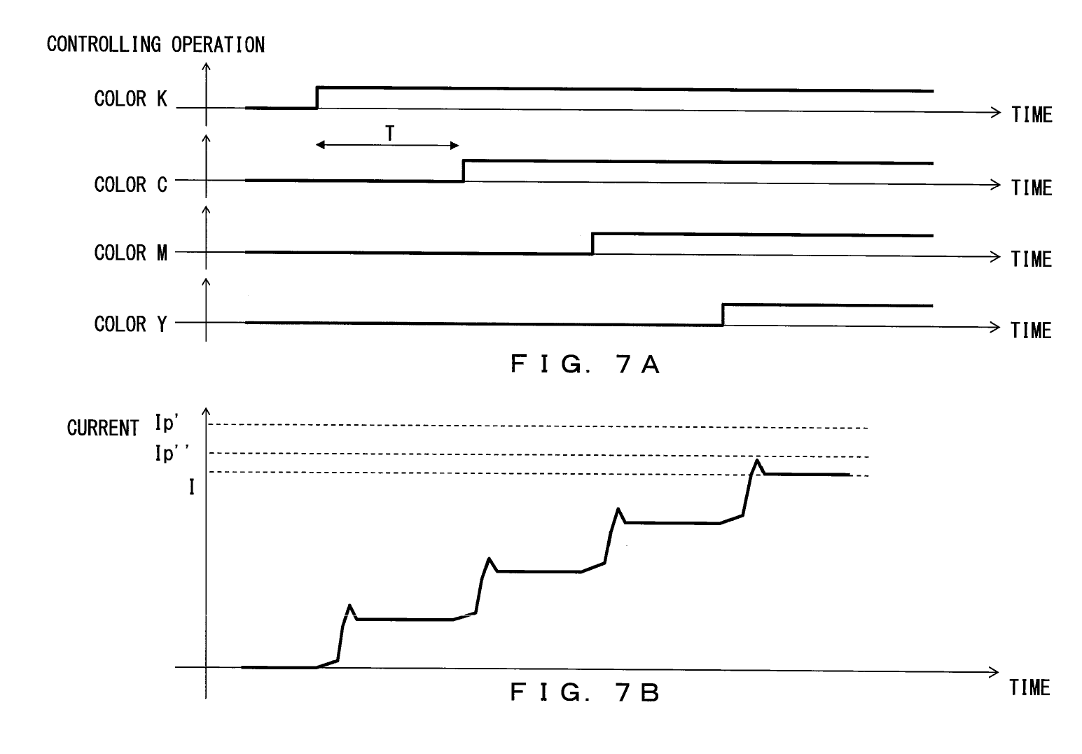

Since the nozzle array drive units 12-1-1 through 12-n-m heat ink according to the instruction, the no inkjet drive B is performed. In this case, a drive block is configured for each color of black (K), cyan (C), magenta (M), and yellow (Y) as illustrated in FIG. 7, and an instruction to start heating the ink of each color is issued at a predetermined time interval.

For example, in the example illustrated in FIG. 7A, an instruction to start heating is issued to the nozzle array drive units 12-1-1 through 12-1-m of black (K). Next, after the time (T) has passed, the instruction to start heating is issued to the nozzle array drive units 12-2-1 through 12-2-m of cyan (C). Then, after additional time (T) has passed, the instruction to start heating is issued to the nozzle array drive units 12-3-1 through 12-3-m of magenta (M). After the time (T) has further passed, the instruction to start heating is issued to the nozzle array drive units 12-4-1 through 12-4-m of the last yellow (Y).

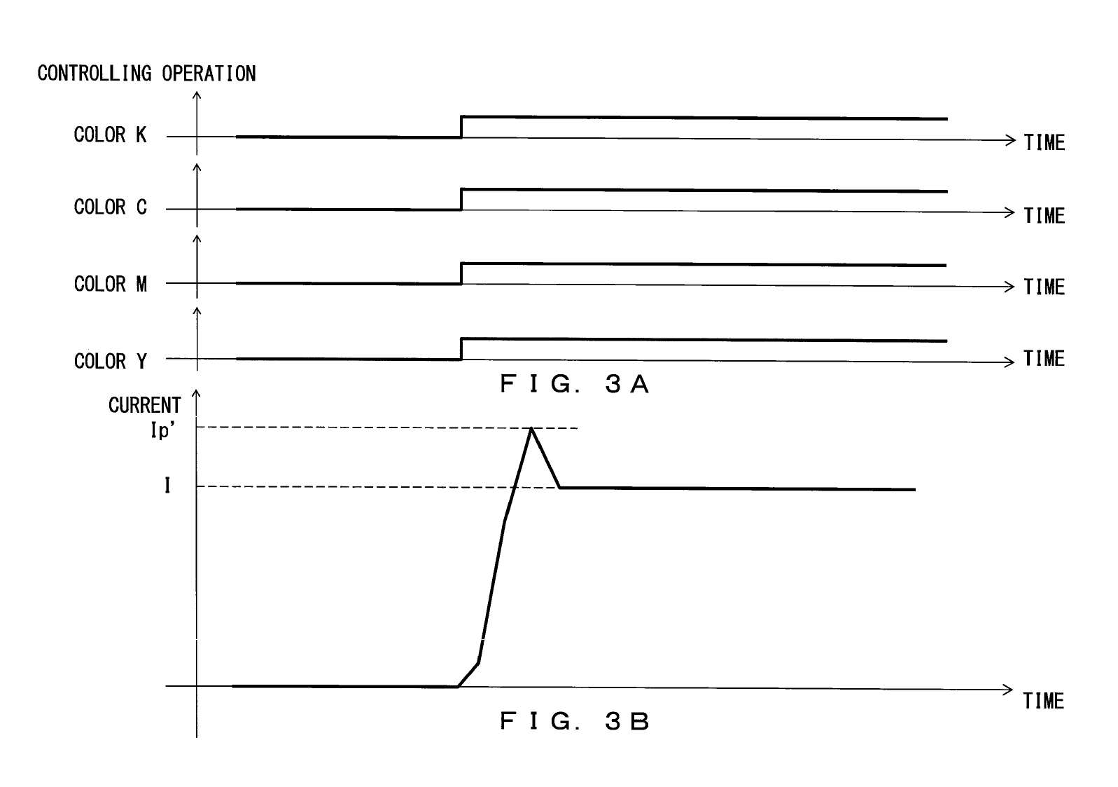

By thus performing control, the current in the circuit has the characteristic in which the current value sequentially rises stepwise as illustrated in FIG. 7B. In yellow (Y) for which the drive is started finally, the generated inrush current is Ip″, and is smaller than the inrush current P′ indicated when each color is simultaneously heated as illustrated in FIG. 3B.

Therefore, in the present embodiment, the maximum power supply capacity of the image recording apparatus 1 can be suppressed in black (K), cyan (C), magenta (M), and yellow (Y) by performing the drive at predetermined time intervals.

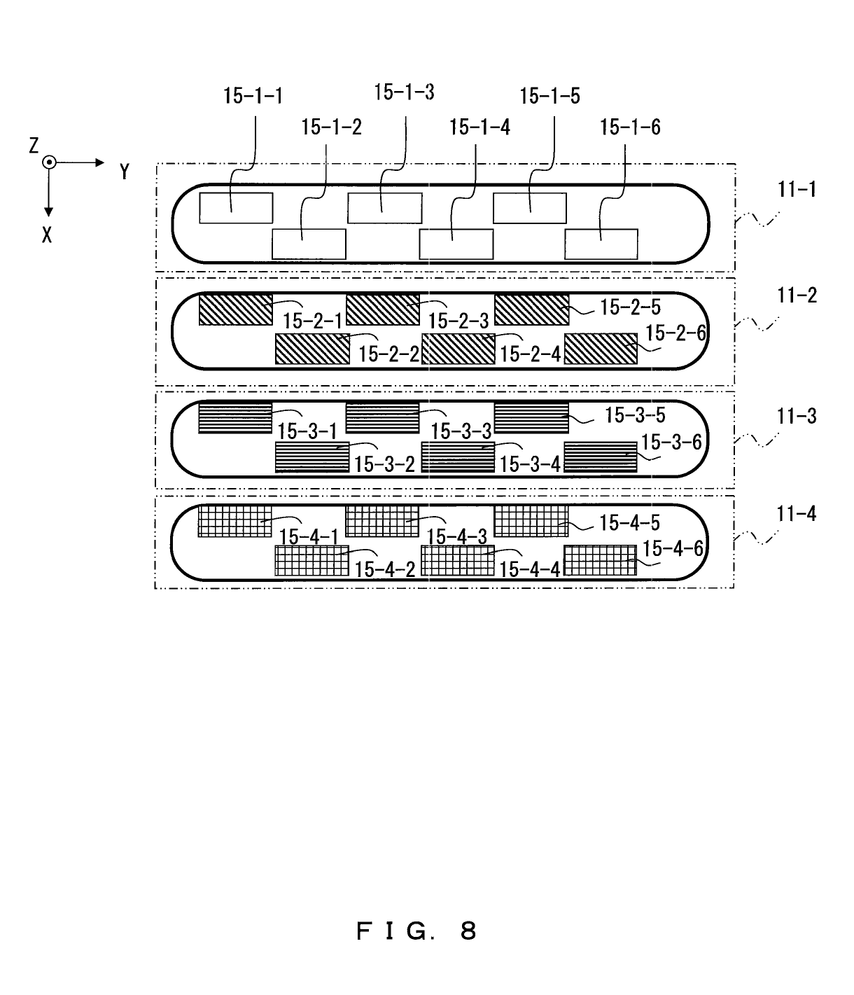

FIG. 8 illustrates the block diagram in the case described above. The example illustrated in FIG. 8 is configured by four recording units 11-1 through 11-4 representing black (K), cyan (C), magenta (M), and yellow (Y). Furthermore, each of the recording units 11-1 through 11-4 is configured by six recording heads 15-1-1 through 15-1-5, 15-2-1 through 15-2-6, 15-3-1 through 15-3-6, and 15-4-1 through 15-4-6.

In this case, in the present embodiment, the recording heads 15-1-1 through 15-1-6, 15-2-1 through 14-2-6, 15-3-1 through 15-3-6, and 15-4-1 through 15-4-6 are driven in this order with the peak current reduced and the maximum power supply capacity suppressed.

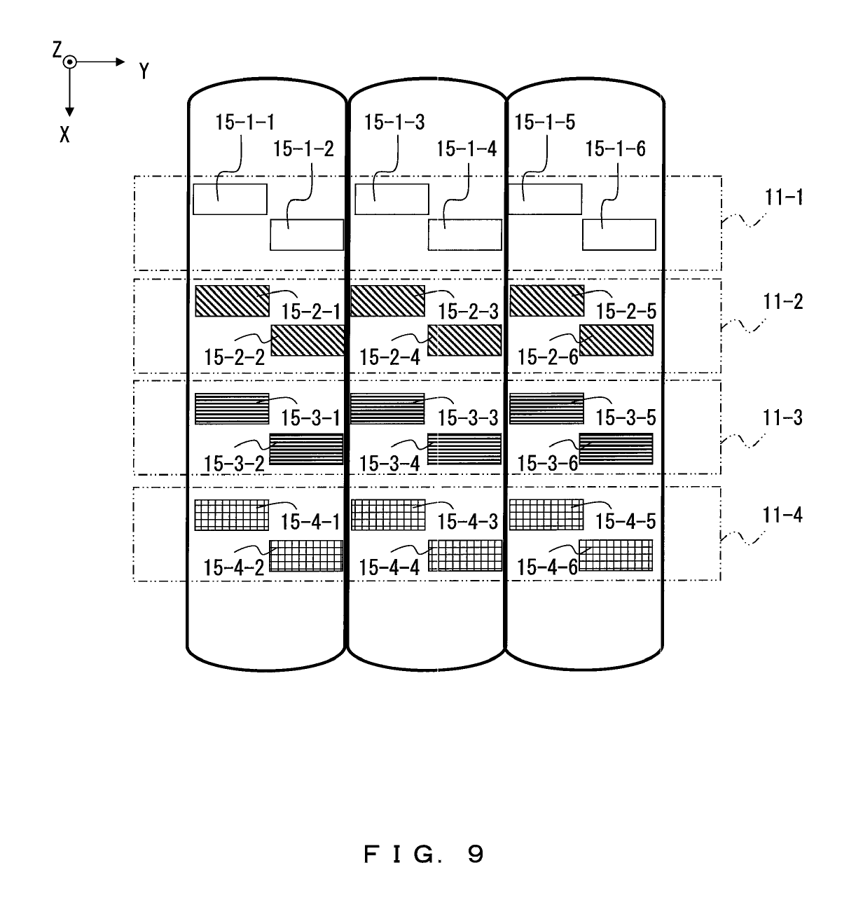

FIG. 9 illustrates an example of a variation of the present embodiment, and the case in which heating control is performed in another block diagram.

In this case, the units are not divided for each of the recording units 11-1 through 11-4, but two recording heads in the recording units 11-1 through 11-4 in different colors are simultaneously driven. That is, as illustrated in FIG. 9, heating the recording heads 15-1-1, 15-1-2, 15-2-1, 15-2-2, 15-3-1, 15-3-2, 15-4-1, and 15-4-2 is started, and then heating the recording heads 15-1-3, 15-1-4, 15-2-3, 15-2-4, 15-3-3, 15-3-4, 15-4-3, and 15-4-4 is started, and finally heating the recording heads 15-1-5, 15-1-6, 15-2-5, 15-2-6, 15-3-5, 15-3-6, 15-4-5, and 15-4-6 is started. Therefore, in the process above, each inrush current is ⅓ of the current obtained when each color is simultaneously heated, thereby successfully suppressing the maximum power supply capacity.

Described next is the second embodiment of the present invention.

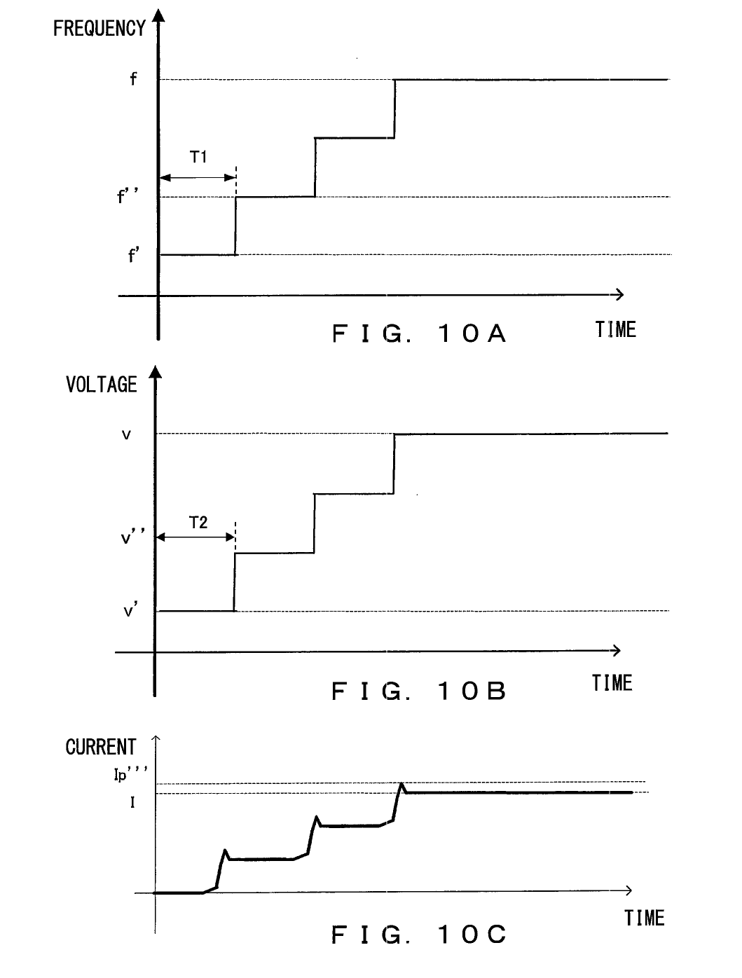

FIGS. 10A through 10C are explanatory views of the second embodiment of the present invention. In the description of the first embodiment above, the maximum power supply capacity can be suppressed by the configuration of the image recording apparatus 1 by shifting the timing of driving the no inkjet drive B. However, in the present embodiment, the image recording apparatus 1 is provided so that the drive condition is changed as follows to suppress the maximum power supply capacity. The practical description is given below.

First, the image recording apparatus 1 for suppressing the maximum power supply capacity by controlling the drive frequency is described. FIG. 10A is an explanatory view of the embodiment. In the present embodiment, immediately after the drive of the no inkjet drive B is started, the frequency f′ lower than a predetermined frequency f (f>f′) is supplied to the nozzle array drive units 12-1-1 through 12-n-m, and the drive is started. Afterwards, the delay time T1 has passed, the nozzle array drive control unit 8 supplies the frequency f″ lower than the predetermined f and higher than the frequency f′ (f>f″>f′), and drives the nozzle array drive units 12-1-1 through 12-n-m.

That is, the drive frequency is divided into several stages, and finally the nozzle array drive units 12-1-1 through 12-n-m are driven at the predetermined frequency f, thereby suppressing the inrush current. FIG. 100 indicates the change of a current in this case, and the maximum current can be reduced. Thus, the maximum power supply capacity of the image recording apparatus 1 can be suppressed.

Next, the image recording apparatus 1 for suppressing the maximum power supply capacity by controlling the drive voltage is described below. FIG. 10B is an explanatory view of the example. In this example, immediately after the start of the drive of the no inkjet drive B, the voltage value V′ lower than a predetermined voltage value V (V>V′) is supplied to the nozzle array drive units 12-1-1 through 12-n-m, and the drive is started. Then, after the delay time T2 has passed, the nozzle array drive control unit 8 applies the voltage of the voltage value V″ lower than a predetermined voltage value V and higher than the voltage value V′ (V>V″>V′), and drives the nozzle array drive units 12-1-1 through 12-n-m.

In this case, the drive voltage is divided into several stages, and finally the nozzle array drive units 12-1-1 through 12-n-m are driven by the predetermined voltage value V, hereby successfully reducing the inrush current, and suppressing the maximum power supply capacity of the image recording apparatus 1.

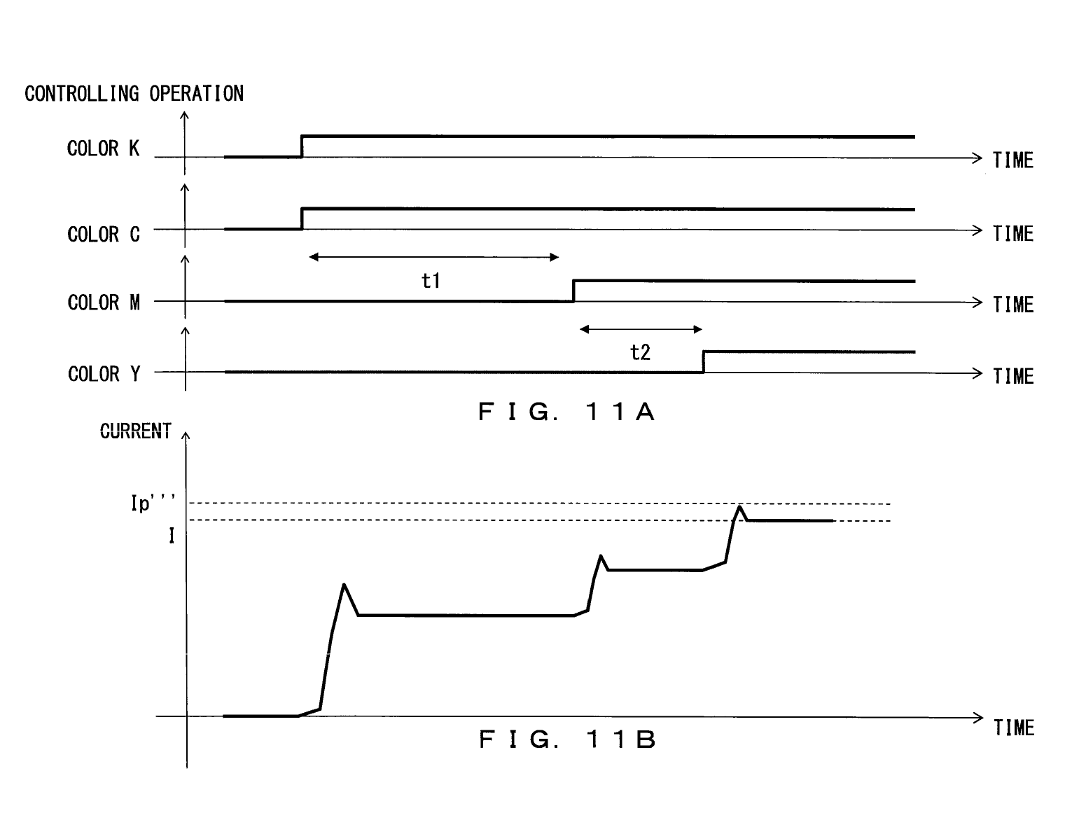

As illustrated in FIG. 11A, heating a plurality of recording units (for example, the recording units 11-1 and 11-2) can be simultaneously started, or the standby heating time t1 and t2 can be variable within the scope of the maximum power supply capacity. In the example above, the current supplied to the recording units 11-1 through 11-4 is illustrated in FIG. 11B.

It is assumed that the above-mentioned heating condition is stored in the storage unit 7, and the nozzle array drive control unit 8 reads the above-mentioned information from the storage unit 7 when the heating of the no inkjet drive B is started, and the drive is controlled.

The present invention is not limited to the above-mentioned first and second embodiments, but can be improved and changed within the scope of the gist of the present invention. For example, some components can be deleted from the entire configuration indicated by the image recording apparatus 1, and the drive can be started in the ascending order of the temperature of ink.

What is claimed is:

1. An image recording apparatus as an aspect of the present invention including at least one recording head having a nozzle array configured by a plurality of nozzles and a nozzle array drive unit for driving the nozzle array, and a conveyance mechanism for loading and conveying a record medium for a recording process using ink conveyed upstream from a conveyance route and jetted from the plurality of nozzles, comprising:
at least a nozzle array drive control unit controlling the nozzle array drive unit; and
a temperature measuring unit detecting the temporarily of the nozzles, wherein
the nozzle array drive control unit measures a temperature of the nozzles, and performs the process of heating ink by performing a weak vibration so that the ink cannot be jetted when the measured temperature is lower than a predetermined temperature.

2. The apparatus according to claim 1, wherein
the nozzle array drive control unit selectively and sequentially drives the recording heads when there are a plurality of nozzles lower than a predetermined temperature.

3. The apparatus according to claim 2, wherein
the selectively and sequentially driven recording heads are configured by blocks of a predetermined size.

4. The apparatus according to claim 3, wherein
the blocks of the predetermined size are recording heads configured for respective colors.

5. The apparatus according to claim 1, wherein
the nozzle array drive control unit variably controls a voltage of the nozzle array drive.

6. The apparatus according to claim 1, wherein
the nozzle array drive control unit variably controls a driving frequency of the nozzle array drive.

7. A method for controlling an image recording apparatus provided with at least one recording head having a nozzle array configured by a plurality of nozzles and a nozzle array drive unit for driving the nozzle array, a conveyance mechanism for loading and conveying a record medium for a recording process using ink conveyed upstream from a conveyance route and jetted from the plurality of nozzles, a nozzle array drive control unit for controlling the nozzle array drive unit, and a temperature measuring unit for detecting the temperature of the nozzles, wherein
the nozzle array drive control unit measures the temperature of the nozzles and performs the process of heating ink by performing a weak vibration so that the ink cannot be jetted when the measured temperature is lower than a predetermined temperature.

8. The method according to claim 7, wherein
the nozzle array drive control unit selectively and sequentially drives the recording heads when there are a plurality of nozzles lower than a predetermined temperature.

9. The method according to claim 7, wherein
the nozzle array drive control unit variably controls a voltage of the nozzle array drive.

10. The method according to claim 7, wherein
the nozzle array drive control unit variably controls a driving frequency of the nozzle array drive.
